(19) United States
(12) Patent Application Publication
(10) Pub. No.: US 2010/0011320 A1
(43) Pub. Date: Jan. 14, 2010

(54) METHOD FOR ASSIGNMENT OF A USER-DEFINED SHORTCUT KEY FOR AN APPLICATION WINDOW TO SWITCH TO IT QUICKLY

(75) Inventors: Ankur B. Shah, Surat (IN); Dhaval K. Shah, Nadiad (IN); Phong A. Pham, Austin, TX (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/171,861

(22) Filed: Jul. 11, 2008

(51) Int. Cl. G06F 3/048

(52) U.S. Cl. 715/811

(57) ABSTRACT

The present disclosure is directed to a method for allowing a user to configure shortcut keys to a specific application.

### TECHNICAL FIELD

The present disclosure generally relates to the field of computer applications, and more particularly to a method to allow a user to configure shortcut keys to a specific computer application.

### BACKGROUND

Modern operating systems and some software programs provide users the ability to perform a certain task by using predetermined shortcut keys. The user presses a combination of shortcut keys and the desired task occurs. These shortcut keys save users time by performing the desired task in a very simple step compared to the methods of manually implementing the desired task. However, there is currently no method that allows a user to configure shortcut keys to a specific application.

### SUMMARY

The present disclosure is directed to a method for allowing a user to configure shortcut keys to a specific application.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram of a method for allowing a user to configure a keystroke sequence to a selected application.

### DETAILED DESCRIPTION

Reference will now be made in detail to the subject matter disclosed, which is illustrated in the accompanying drawings.

The present disclosure is directed to a method for allowing a user to configure a keystroke sequence to a selected application. Upon the entering of the keystroke sequence that was previously recorded, the operating system may cause the corresponding selected application to become an active application.

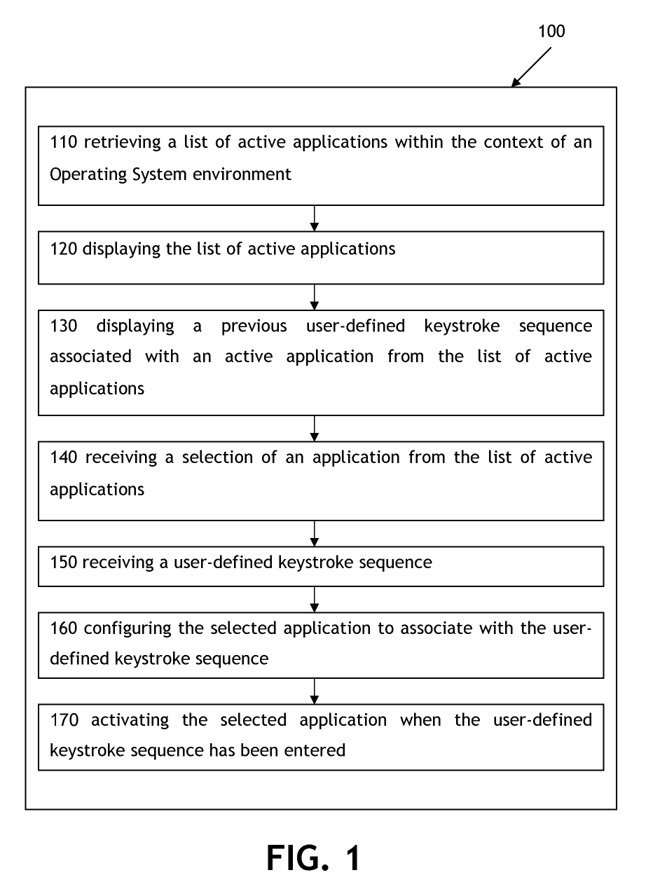

Referring to FIG. 1, a flow diagram of a method 100 for allowing a user to configure a keystroke sequence to a selected application is depicted. Method 100 includes retrieving a list of active applications within the context of the Operating System environment 110. The method 100 then displays the list of active applications 120. Upon displaying the list of active applications 120, the method 100 displays the previous user-defined keystroke sequences associated with the active applications 130. Then, a selected application is received from the list of active applications 140. Then, the method 100 receives a user-defined keystroke sequence 150 and configures the selected application to associate with the user-defined keystroke sequence 160. Finally, the method 100 activates the selected application when the user-defined keystroke sequence has been entered 170.

For example, the user may activate the method for assigning a shortcut key by pressing a certain key sequence (e.g. CTRL+ALT+BACKSPACE). The method retrieves and displays the list of active applications and their respective keystroke sequences, if any. The user may then select an active application (selected application) and edit the shortcut key for that application. The user may enter any key combination (e.g. CTRL+ALT+1) on the keyboard to configure the selected application to the key combination. To jump to the selected application, the user would activate the method for assigning a shortcut key (CTRL+ALT+BACKSPACE) and then pressing the corresponding key sequence. The method for assigning a shortcut key deletes the shortcut key assignment automatically when the selected application is closed.

An example of a list of all applications and corresponding keystroke sequences:

| Window Name | Keystroke sequence |
|---|---|
| IE: Gmail. | CTRL + ALT + 1 |
| IE: iGoogle | CTRL + 1 |
| IE: Search Cricket | CTRL + 2 |

On assigning a keystroke sequence, a confirmation window may pop up asking a user to confirm the keystroke sequence assignment. This is a configurable option.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for assigning a shortcut key comprising:
retrieving a list of active applications within the context of an Operating System environment;
displaying the list of active applications;
displaying a previous user-defined keystroke sequence associated with an active application from the list of active applications;
receiving a selection of an application from the list of active applications;
receiving a user-defined keystroke sequence;
displaying a confirmation window, wherein the confirmation window is configured to receive a confirmation associated with the user-defined keystroke sequence;
receiving the confirmation associated with the user-defined keystroke sequence;
configuring the selected application to associate with the user-defined keystroke sequence;
activating the selected application when the user-defined keystroke sequence has been entered; and
deleting the user-defined keystroke sequence when the selected application is closed.
